(19) United States
(12) Patent Application Publication
(10) Pub. No.: US 2006/0238501 A1
(43) Pub. Date: Oct. 26, 2006

(54) Video card with a control input/output module

(75) Inventor: Fou-Ming Liou, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ASUSTeK Computer Inc.

(21) Appl. No.: 11/399,132

(22) Filed: Apr. 6, 2006

(30) Foreign Application Priority Data
Apr. 20, 2005 (TW) 94112616

(51) Int. Cl. G09G 5/00

(52) U.S. Cl. 345/156

(57) ABSTRACT

A video card has a processor and a cable. The processor is configured on the video card and has a control input/output (digital I/O, DI/O) module. The control input/output module outputs or receives a control signal. The cable is electrically connected to the processor and transmits the control signal between the processor and an external electronic device.

### RELATED APPLICATIONS

The present application is based on, and claims priority from, Taiwan Application Serial Number 94112616, filed Apr. 20, 2005, the disclosure of which is hereby incorporated by reference herein in its entirety.

### BACKGROUND

1. Field of Invention

The present invention relates to a video card. More particularly, the present invention relates to a video card with a control input/output module.

2. Description of Related Art

A control input/output (digital I/O, DI/O) card, an interface card adapted to a computer system, is widely used and very important in the industrial control field. When the computer system runs programs, the control input/output card can output control signals to control an external switch or relay; or the control input/output card can receive a state signal (e.g., an on-state signal or an off-state signal) as a reference for user manipulation or program processing.

FIG. 1 is a schematic view of a conventional computer system configuring a control input/output card and its peripheral device. A display card 102 and a control input/output card 104 are simultaneously configured in a computer system 100. The display card 102 is connected to a display 122 with a video cable 112 for transmitting video signals. The control input/output card 104 is connected to an expansion card 124 with another control signal cable 114 (e.g., a bus line) for outputting or receiving control signals.

As seen in FIG. 1, according to the conventional configuration, the display card 102 and the control input/output card 104 must occupy two interface slots of the computer system 100. However, a typical computer system has only a finite quantity of interface slots and limited resources allocated to those slots, so the quantity of interface slots cannot be arbitrarily expanded. Furthermore, if some work simultaneously involves the display card 102 and the control input/output card 104, the conventional configuration not only exhibits difficulties in signal transmission but also significantly increases the processor loading of the computer system 100, thus the performance of computer system 100 are encumbered.

### SUMMARY

It is therefore an aspect of the present invention to provide a video card, in which a control input/output module is integrated, to fully use the resource of the video card and enable more applications.

It is another an aspect of the present invention to provide a video card having a control input/output module, which simplifies signal transmission paths and decreases the processor loading of the computer system.

According to one preferred embodiment of the present invention, the video card includes a processor and a cable. The processor is configured on the video card and has a control input/output module arranged to output or receive a control signal. The cable is electrically connected to the processor and transmits the control signal between the processor and an external electronic device.

It is to be understood that both the foregoing general description and the following detailed description are examples and are intended to provide further explanation of the invention as claimed.

### BRIEF DESCRIPTION OF THE DRAWINGS

These and other features, aspects and advantages of the present invention will become better understood with regard to the following description, appended claims and accompanying drawings where:

FIG. 1 is a schematic view of a conventional computer system configuring a control input/output card and its peripheral device;

FIG. 2A is a schematic view of one preferred embodiment of the present invention;

FIG. 2B is a schematic view of another preferred embodiment of the present invention;

FIG. 2C is a schematic view of another preferred embodiment of the present invention; and

FIG. 3 is a schematic view of a computer system and its peripheral device in one preferred embodiment of the present invention.

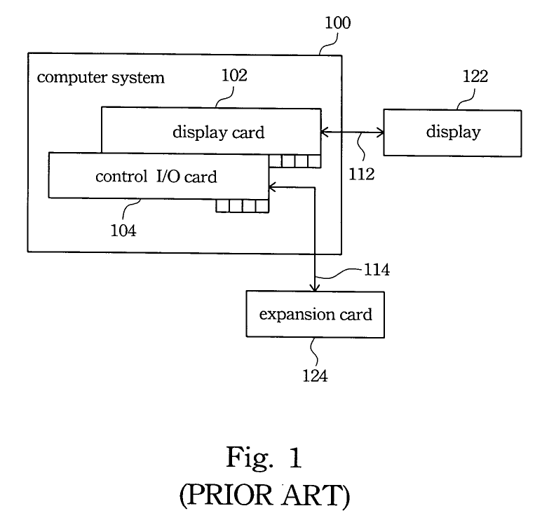

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention integrates a control input/output module into a video card, which can output or receive control signals by pins of its processor. Thus, the present invention not only efficiently uses the resource of the video card but also improves the interactions between video signals and control signals, simplifying signal transmission paths and decreasing the processor loading of the computer system.

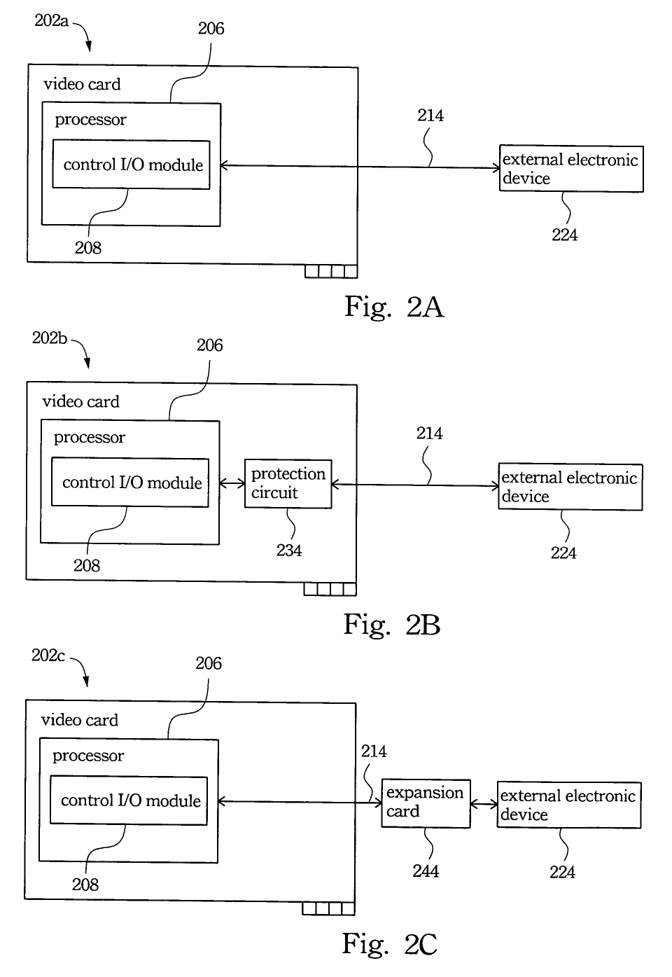

FIG. 2A is a schematic view of one preferred embodiment of the present invention. A video card 202a includes a processor 206 and a cable 214. The processor 206 is configured on the video card 202a and has a control input/output module 208. The control input/output module 208 outputs or receives a control signal. The cable 214 is electrically connected to the processor 206 and transmits the control signal between the processor 206 and an external electronic device 224.

The video card 202a can be a display card, a television capture card or other interface card with video functions. The processor 206 can be an image processing chip or an input/output chip. For example, the image processing chip of the modern video card generally has some unused general-purpose input/output (GPIO) pins. Therefore, the control input/output module can be implemented in the video card by using those available pins for outputting or receiving control signals and incorporating the proper software control.

In other words, the processor has multiple pins, of which one portion processes video signals, and another portion processes control signals. Persons skilled in the art should understand that in some designs and arrangements, control signals can be outputted or received by the pins which originally have other functions and are not limited to the above-mentioned originally unused pins.

In addition, if there are not enough remaining pins of the image processing chip originally configured on the video card, or if the loading of the image processing chip is to be shared, another input/output chip can be additionally configured on the video card for outputting, receiving and even processing the control signals. In this case, the above-mentioned control input/output module is implemented in the additional input/output chip. It is noted that if a video card simultaneously has both the image processing chip and the input/output chip, the control input/output module can be simultaneously implemented partially in the image processing chip and partially in the input/output chip via some suitable circuit layouts and software support.

The cable in the preferred embodiment can be an S-Video cable, a digital visual interface (DVI) cable or a bus line. One preferred embodiment of the present invention can use the S-Video cable or the digital visual interface cable to enhance the interactive applications between its control and video signals, which is described as follows.

FIG. 2B is a schematic view of another preferred embodiment of the present invention. By comparing the embodiment illustrated in FIG. 2A, a video card 202b further includes a protection circuit 234. As described above, the processor 206 for outputting and receiving control signals may be an image processing chip. The image processing chip usually has extremely fast processing speed and powerful image processing functionality, and therefore its cost is very expensive. In order to prevent the expensive processor 206 from being accidentally damaged by the inputted control signal, the preferred embodiment electrically connects the protection circuit 234 between the processor 206 and the cable 214. The protection circuit 234 can filter out the control signals with large currents or high voltages, preventing a control signal from directly impacting the processor 206 and damaging its original image processing functionality.

In another aspect, the control signal outputted or received by the control input/output module 208 generally is a switching signal with a high logic level (e.g., +3.3V or +5V) and a low logic level (e.g., +0V or a negative voltage). However, the value of voltages or currents of the simple switching signal may not be enough for use. Moreover, the two different logic levels, one high logic level and one low logic level, do not offer many variations in practice. Therefore, another preferred embodiment of the present invention further provides an expansion card to provide multiple logic levels.

FIG. 2C is a schematic view of another preferred embodiment of the present invention. By comparing the embodiment illustrated in FIG. 2A, a video card 202c further includes an expansion card 244. The expansion card 244 is electrically connected between the cable 214 and the external electronic device 224 for adjusting the control signal. For example, the control signal outputted or received by the control input/output module 208, whose voltage or current can be magnified or minified by the expansion card 224, can accommodate the suitable range for the control input/output module 208 or the external electronic device 224.

Alternatively, the expansion card 224 can further generate a voltage, a current or another oscillation signal with a certain frequency according to the control signal (e.g., the control signal transmitted from the control input/output module 208 to the external electronic device 224, or the control signal transmitted from the external electronic device 224 to the control input/output module 208) for inputting to the control input/output module 208 or the external electronic device 224.

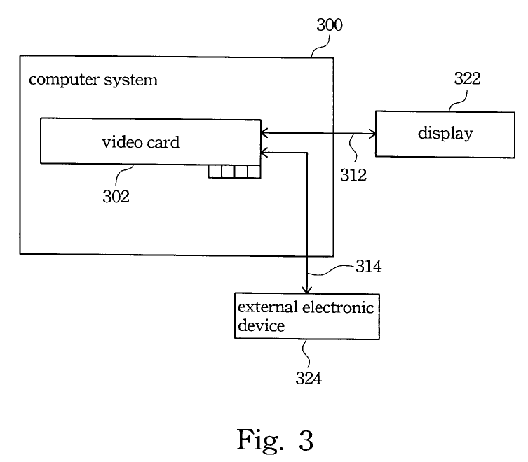

FIG. 3 is a schematic view of a computer system and its peripheral device in one preferred embodiment of the present invention. A computer system 300 has a video card 302 with a control input/output module. The video card 302 is connected to a display 322 with a video cable 312 for transmitting video signals and outputs a control signal to an external electronic device 324 or receives a control signal from the external electronic device 324 through a control signal cable 314, such as a bus line.

It is noted that, if the external electronic device 324 is electrically connected to the display 322, such as the external electronic device 324 integrated in the display 322 or the external electronic device electrically connected to the video card 302 through the display 322, the video cable 312 and the control signal cable 314 can be integrated into a single cable, such as the S-Video cable or the DVI cable which includes several unused wires inside.

The following descriptions illustrate several applications and variations of the abovementioned embodiments. These applications explain in detail how the video signal and the control signal interact with each other by the video signal of the video card and the outputted control signal, by the video signal of the video card and the received control signal, and by the video signal of the video card and the outputted and received control signals, separately.

In the following applications, the cable preferably is an S-Video cable or a DVI cable. The S-Video cable or the DVI cable has several unused wires, which can be used to transmit the above-mentioned control signal, and therefore the S-Video cable or the DVI cable is especially suitable for applications that transmit the video signal and the control signal at the same time.

By this configuration, the control signal cable for transmitting control signals and the video cable for transmitting video signals can be combined in a single cable, reducing the cost and occupied space. However, another transmission manner of two separate cables for the control signals and the video signals still should meet the spirit and fall into the scope of the present invention.

The first application explains the interactive relation between the video signal of the video card and the control signal outputted from it. In this application, the external electronic device is a display with a special function, such as a computer monitor attaching a lighting device or a driving device controlled by the control signal outputted from the control input/output module.

More precisely, the external electronic device can be a computer monitor attaching a lighting device, such as light emitting diodes (LEDs). When the video card transmits the video signals to the computer monitor through the cable, the video card can also transmit the control signal to the computer monitor through the same cable to make the lighting device flashing or continuously shining under a predetermined condition, such as continuously playing certain video signals for a while, or finishing the playing of certain video signals.

In another aspect, the external electronic device can be a computer monitor attaching a driving device, such as a shaking device or a lifting device. When the video card transmits the video signals to the computer monitor through the cable, the video card can also transmit the control signal to the computer monitor through the same cable to make the driving device to drive the computer monitor, for example, shaking or lifting the computer monitor, under a predetermined condition, such as when triggered by a certain video signal, or starting or finishing playing the video signals.

The second application explains the interactive relation between the video signal of the video card and the control signal inputted to it. In this application, the external electronic device is a sensor, such as a simple mechanical sensor or a complicated electronic sensor. According to the sensed situation, the sensor can generate a control signal for the control input/output module to be a reference for determining and corresponding actions.

More precisely, the sensor can be a door sensor installed on a door to sense whether the door is opened or closed. The door sensor can generate an open signal (e.g., a control signal with a high logic level) and a closed signal (e.g., a control signal with a low logic level) according to the opening or closing of the door, respectively. Moreover, the sensor can incorporate or additionally connect to a recording device, such as a video recorder. The video data captured by the recording device is also transmitted through the same cable.

When the door is opened, the door sensor correspondingly generates the open signal and transmits the open signal to the control input/output module through the cable. After the receipt of the open signal, the control input/output module starts a record procedure to record the video data which is captured by the recording device and then transmitted through the same cable. By this configuration, this application can be applied to an access control system, in which only a video card directly records a scene when the door opens, and the recording is efficient without occupying large memory volume.

The above-mentioned record procedure can be terminated by the closed signal generated by the door sensor, or by a fixed recording time, or by only taking one picture (e.g., a photograph) at every opening of the door. Persons skilled in the art should understand that this application can be modified or adjusted according to the practical requirement, and its implementation is not limited to the examples as described above.

The third application explains the interactive relation among the video signal of the video card, the control signal inputted to it and the control signal outputted from it. In this application, the external electronic device is a touch screen. The following firstly interprets the signal transmission of a conventional touch screen.

The conventional touch screen consists of a display portion and a touch panel configured on the display portion. When sensing a user's pressing, the touch panel generates a position signal in response to the position which is pressed, and the position signal is transmitted to a computer system through a conventional cable, such as an RS232 cable, a PS2 cable or a USB cable. The computer system renders the position signal and cooperates with a driver of the video card to transmit a corresponding image through another video cable and display it on the display portion, completing the displaying of the user's touch.

In other words, the conventional touch screen, in which the video signals and the position signals are transmitted through different cables, needs a larger physical space and also has complicated signal transmission paths. Moreover, the interactions of the two signals are both processed by the processor of the computer system, thus lowering the computer performance and occupying its finite system resource.

In the third application, the same cable is used to transmit the position signal and the video signal. Moreover, the interactions of the two signals can be totally handled by the processor of the video card, thus completing most of the displaying of the user's touch directly by the video card.

More precisely, the touch screen of the third application similarly consists of a display portion and a touch panel configured on the display portion, but both the display portion and the touch panel are electrically connected to the same cable, such as an S-Video cable or a DVI cable, for transmitting and receiving the video signal and the control signal.

When sensing a user's pressing, the touch panel generates a position signal in response to the position which is pressed, and the position signal is transmitted to the control input/output module of the video card through a cable. Afterward, the processor of the video card renders the position signal and interactively processes it with the video signals which are also processed by the processor, so as to complete most of the displaying of the user's touch directly by the video card. Therefore, the transmission path between signals is effectively simplified, and the processor loading of the computer system is also substantially reduced.

It will be apparent to those skilled in the art that various modifications and variations can be made to the structure of the present invention without departing from the scope or spirit of the invention. In view of the above-mentioned, it is intended that the present invention cover modifications and variations of this invention provided they fall within the scope of the following claims and their equivalents.

What is claimed is:

1. A video card, comprising:
a processor, configured on the video card, wherein the processor has a control input/output module arranged to output or receive a control signal; and
a cable, electrically connected to the processor and arranged to transmit the control signal between the processor and an external electronic device.

2. The video card of claim 1, wherein the processor is an image processing chip or an input/output chip.

3. The video card of claim 1, wherein the processor has a plurality of pins, one portion of the pins is arranged to process video signals, and another portion of the pins is arranged to process the control signal.

4. The video card of claim 1, wherein the cable is an S-Video cable, a digital visual interface cable or a bus line.

5. The video card of claim 1, further comprising a protection circuit electrically connected between the processor and the cable, wherein the protection circuit is arranged to prevent the processor from being damaged by the received control signal.

6. The video card of claim 1, wherein the control signal is a switching signal with a high logic level or a low logic level.

7. The video card of claim 1, further comprising an expansion card electrically connected between the cable and the external electronic device, wherein the expansion card is arranged to adjust the control signal.

8. The video card of claim 7, wherein the expansion card is arranged to magnify or minify the control signal.

9. The video card of claim 7, wherein the expansion card is arranged to generate a voltage or a current according to the control signal.
